(19) United States
(12) Patent Application Publication
(10) Pub. No.: US 2024/0070681 A1
(43) Pub. Date: Feb. 29, 2024

(54) SYSTEMS AND METHODS FOR ENTITY RESOLUTION

(71) Applicant: Capital One Services, LLC, Mclean, VA (US)

(72) Inventors: Lin Ni Lisa Cheng, New York, NY (US); Wade Rance, Washington, DC (US); Alexis Howard, Cobbs Creek, VA (US)

(21) Appl. No.: 17/896,117

(22) Filed: Aug. 26, 2022

(51) Int. Cl. G06Q 30/00; G06F 16/215; G06F 16/25

(52) U.S. Cl. CPC G06Q 30/018; G06F 16/215; G06F 16/258

(57) ABSTRACT

Disclosed embodiments may include systems and methods for entity resolution. The system may receive a first plurality of identifiers and a taxpayer identification number. The system may determine one or more profiles preliminarily associated with the entity the one or more profiles including a plurality of data entries. The system may convert the plurality of data entries from a non-standardized format to a standardized format. The system may compare the first plurality of identifiers and the taxpayer identification number to the plurality of data entries to determine an entity match. In some examples, the system can vectorize the first plurality of identifiers and the taxpayer identification number into a first vectorized dataset and the plurality of data entries into one or more second vectorized datasets. The system may compare the first vectorized dataset to the one or more second vectorized dataset to determine an entity match.

The disclosed technology relates to systems and methods for entity resolution. Specifically, this disclosed technology relates to automatically processing an organization's application for a business account and determining whether the provided information matches an existing account.

### BACKGROUND

Organizations, such as small and medium-sized businesses, have a need to open business financial accounts. For example, an organization may need to apply for a business bank account or credit card account. Often, the information provided by an organization can be matched to an existing financial account, and the financial service provider has to determine whether the match is in error. Traditional systems and methods for applying for financial accounts require a financial institution to manually review the organization's identifying information, thus requiring a lot of time and resources to process and approve the business financial account.

Accordingly, there is a need for improved systems and methods for entity resolution. Embodiments of the present disclosure are directed to this and other considerations.

### SUMMARY

Disclosed embodiments may include a system for entity resolution. The system may include one or more processors, and memory in communication with the one or more processors and storing instructions that, when executed by the one or more processors, are configured to cause the system to provide entity resolution. The system may receive a first plurality of identifiers from an entity device associated with the entity. The first plurality of identifiers can include an entity name and an entity address. The system may receive a taxpayer identification number associated with the entity. Using the first plurality of identifiers, the system can query one or more external data sources to determine one or more profiles that include a plurality of data entries stored in a non-standardized format dependent on the one or more external data sources. The system can convert the plurality of data entries from the non-standardized format to a standardized format. The system can compare the first plurality of identifiers and the taxpayer identification number to the plurality of data entries in the standardized format. In response to zero profiles matching the taxpayer identification number beyond a predetermined threshold, the system can request validation of the first plurality of identifiers from the entity device. In response to a first profile matching the taxpayer identification number and one or more of the first plurality of identifiers partially matching the first profile beyond the predetermined matching threshold, the system may notify the entity device of a first profile partial match. In response to a plurality of profiles of the one or more profiles matching the taxpayer identification number and the first plurality of identifiers beyond the predetermined matching threshold, the system may receive merchant data from the entity device, determine whether the plurality of profiles comprise duplicate profiles each associated with the entity based on the merchant data, and notify the entity device that the plurality of profiles include duplicate profiles that are each associated with the entity.

Disclosed embodiments may include a system for entity resolution. The system may include one or more processors, and memory in communication with the one or more processors and storing instructions that, when executed by the one or more processors, are configured to cause the system to provide entity resolution. The system can receive a first plurality of identifiers from an entity device associated with the entity. The first plurality of identifiers can include an entity name, an entity address, and a taxpayer identification number. The system may vectorize each of the first plurality of identifiers to form a first vectorized dataset. The system may identify one or more profiles preliminarily associated with the entity, and each of the one or more profiles can include a plurality of data entries stored in a non-standardized format. The system may convert the plurality of data entries from the non-standardized format to a standardized format. For each of the one or more profiles, the system may vectorize the standardized plurality of data entries to form one or more second vectorized datasets. The system may determine, using a machine learning model, a match between at least a second vectorized dataset of the one or more second vectorized datasets and the first vectorized dataset. The second vectorized dataset can be associated with a second profile of the one or more profiles. In response to the match not exceeding a first threshold, the system can request validation of the first plurality of identifiers from the entity device. In response to the match exceeding the first threshold, the system may notify the entity device of a partial profile match. In response to the match exceeding a second threshold, the system may notify the entity device of the match to a profile of the one or more profiles wherein the first profile is associated with the second vectorized dataset.

Disclosed embodiments may include a system for entity resolution. The system may include one or more processors, and memory in communication with the one or more processors and storing instructions that, when executed by the one or more processors, are configured to cause the system to provide entity resolution. The system may receive a first plurality of identifiers from an entity device associated with an entity. The first plurality of identifiers can include an entity name, an entity address, and a taxpayer identification number. The system may vectorize each of the first plurality of identifiers to forma first vectorized dataset. The system can identify one or more profiles that are preliminarily associated with the entity. Each of the one or more profiles can include a plurality of data entries. For each of the one or more profiles, the system may vectorize the plurality of data entries to form one or more second vectorized datasets. The system may determine, using a machine learning model, a match between at least a second vectorized dataset of the one or more second vectorized datasets and the first vectorized dataset. The second vectorized dataset can be associated with a second profile of the one or more profiles. In response to the match not exceeding a first threshold, the system can request validation of the first plurality of identifiers from the entity device. In response to the match exceeding the first threshold, the system may notify the entity device of a partial profile match. In response to the match exceeding a second threshold, the system may notify the entity device of the match to a first profile of the one or more profiles. The first profile can be associated with the second vectorized dataset.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1A is a flow diagram illustrating an exemplary method for entity resolution in accordance with certain embodiments of the disclosed technology.

FIG. 1B is a flow diagram illustrating an exemplary method for entity resolution in accordance with certain embodiments of the disclosed technology.

FIG. 2 is a flow diagram illustrating an exemplary method for entity resolution in accordance with certain embodiments of the disclosed technology.

FIG. 3 is block diagram of an example entity determination system used to provide entity resolution, according to an example implementation of the disclosed technology.

FIG. 4 is block diagram of an example system that may be used to provide entity resolution, according to an example implementation of the disclosed technology.

### DETAILED DESCRIPTION

Examples of the present disclosure related to systems and methods for entity resolution. More particularly, the disclosed technology relates to determining whether a match exists between an entity and one or more profiles based on comparing a plurality of identifiers provided by the entity to one or more data entries associated with the one or more profiles. The systems and methods described herein utilize, in some instances, machine learning models, which are necessarily rooted in computers and technology. Machine learning models are a unique computer technology that involves training models to complete tasks and make decisions. The present disclosure details analyzing a plurality of identifiers and matching them to data entries associated with one or more profiles. This, in some examples, may involve using entity identifier input data and a natural language processing machine learning model, applied for entity resolution, and outputs a result of a similarity score to each of the one or more profiles. Using a machine learning model in this way may allow the system to autonomously determine whether an existing matching profiles exists for a business entity without requiring manual human review. This is a clear advantage and improvement over prior technologies that require human intervention to determine whether a business entity applying for a financial account already has a matching profile with a financial institution because the present examples do not require manual human intervention, unlike traditional solutions. The present disclosure solves this problem by using natural language processing and machine learning to autonomously match an entity to one of one or more existing profiles. Furthermore, examples of the present disclosure may also improve the speed with which computers can process an application of a business entity for a financial product. Overall, the systems and methods disclosed have significant practical applications in the financial data processing field because of the noteworthy improvements of the automated the entity resolution process, which is important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

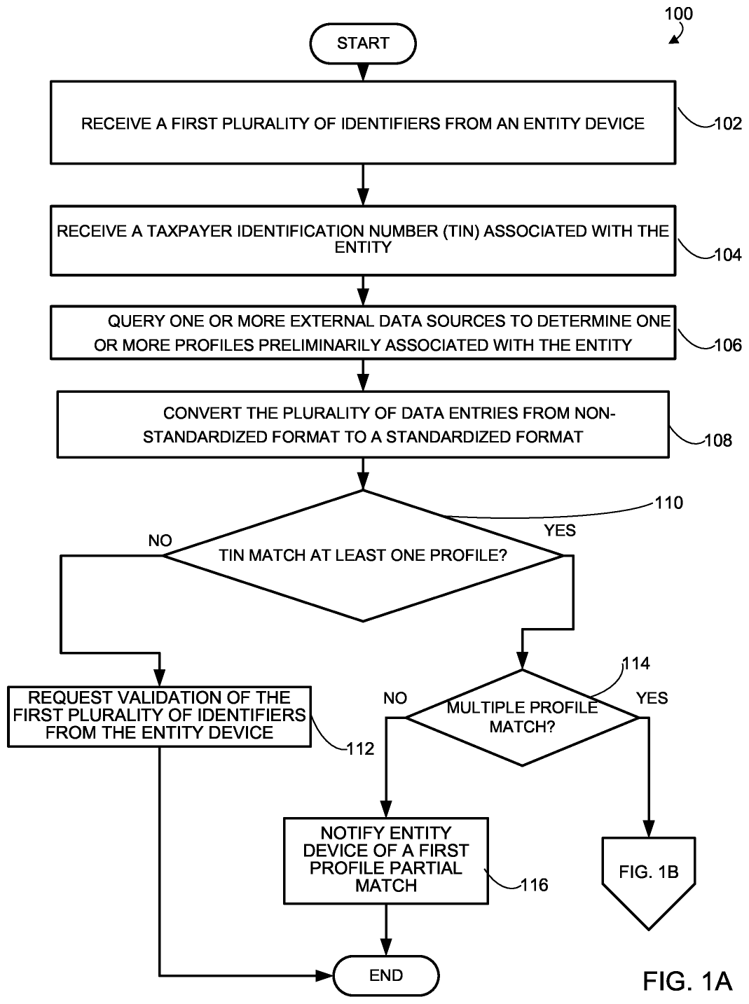

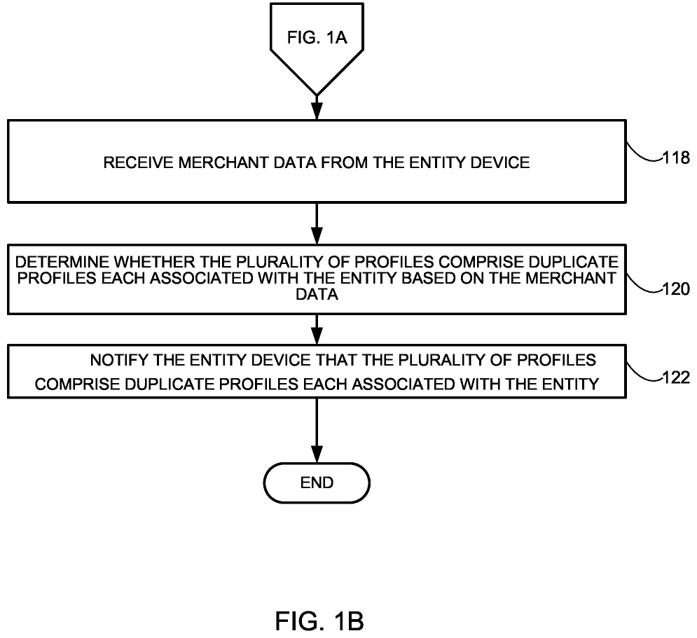

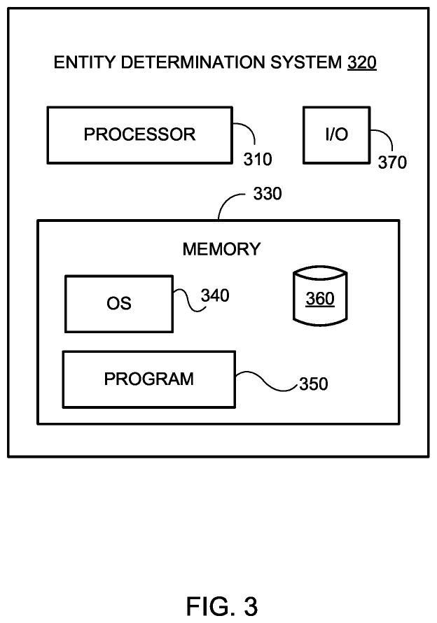

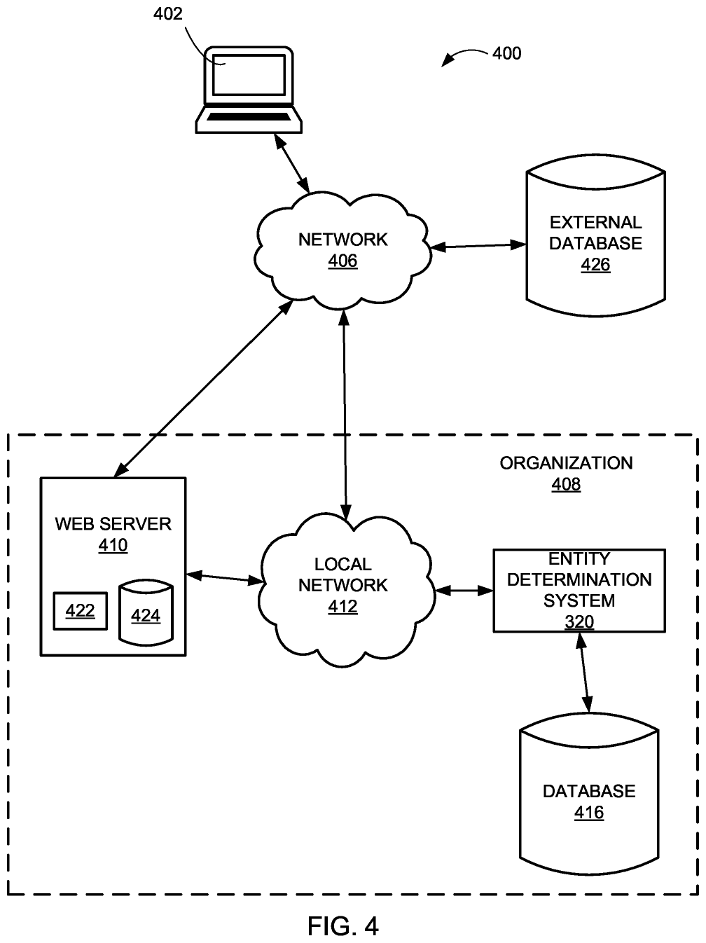

FIG. 1A is a flow diagram illustrating an exemplary method 100 for entity resolution, in accordance with certain embodiments of the disclosed technology. The steps of method 100 may be performed by one or more components of the system 400 (e.g., entity determination system 320 or web server 410 of organization 408 or entity device 402), as described in more detail with respect to FIGS. 3 and 4.

In block 102, the entity determination system 320 may receive a first plurality of identifiers from an entity device (e.g., entity device 402). The first plurality of identifiers can include an entity name and an entity address. Other identifiers can be included, for example, a business license, ownership agreements providing ownership information with respect to the entity, any entity formation documents (e.g., articles of incorporation for a corporation, articles of organization for a limited liability company, partnership agreement for a partnership, etc.), an employer identification number (EIN), and/or a social security number when the entity is a sole proprietorship. The above list is not exhaustive, and first plurality of identifiers can include more or less documents than those listed.

In block 104, the entity determination system 320 may receive a taxpayer identification number (TIN) associated with the entity. In some embodiments, in order to apply for a financial product for a business entity, the business entity may be required to provide a TIN. The financial product that the entity is applying for can be of any type, including but not limited to a business bank account, a business credit account, a loan product, etc.

In block 106, the entity determination system 320 may query one or more external data sources to determine one or more profiles preliminarily associated with the entity. For example, entity determination system 320 may access an external database 426 to compare the received first plurality of identifiers to data entries associated with one or more profiles. Entity determination system 320 may use a data matching algorithm to compute a similarity metric between the plurality of identifiers and the data entries associated with the one or more profiles to determine one or more profiles that are preliminarily associated with the plurality of identifiers. For example, if the data entries associated with a first profile of the one or more profiles match the plurality of identifiers beyond a predetermined confidence threshold, the entity determination system may determine a match preliminary match between the first profile and the plurality of identifiers. In some examples, the entity determination system 320 can query one or more internal data sources to determine one or more profiles preliminarily associated with the entity. For example, entity determination system 320 can query an internal database 416 to determine one or more profiles that are preliminarily associated with the plurality of identifiers. In some examples, before querying one or more external data sources, the entity determination system 320 may standardize the first plurality of identifiers in a similar manner as described below with respect to block 108.

In block 108, the entity determination system 320 may convert the plurality of data entries from a non-standardized format to a standardized format. In some examples, converting the plurality of data entries from a non-standardized format to a standardized format can include adjusting the case of the plurality of data entries. For example, each data entry can be modified to be written in all capital letters to facilitate matching the plurality of data entries to the first plurality of identifiers. In some examples, converting the plurality of data entries from a non-standardized format to a standardized format can include standardizing diacritics. Standardizing diacritics can include removing diacritics and replacing them with normal letters. For example, if the symbol “A” appears within the first plurality of identifiers the entity determination system 320 can remove the diacritic mark and replace it with the standard letter “A.” In some examples, converting the plurality of data entries from a non-standardized format to a standardized format can include standardizing corporate extensions. For example, the term “corporation” may be standardized to “corp” and “limited liability company” may be standardized to “LLC,” etc. In some examples, converting the plurality of data entries from a non-standardized format to a standardized format can include removing filler words. For example, words such as “the,” “a,” “an,” etc. can be removed from the plurality of data entries because such words do not improve the ability for entity determination system 320 to determine a match between the first plurality of identifiers and the plurality of data entries of the one or more profiles. In some examples, converting the plurality of data entries from a non-standardized format to a standardized format can include removing symbols. For example symbols such as “@” may be removed from the plurality of identifiers.

In decision block 110, the entity determination system 320 may determine whether the taxpayer identification number associated with the entity device matches at least one profile. The entity determination system 320 can compare the first plurality of identifiers and the taxpayer identification number to the plurality of data entries in the standardized format. The first plurality of identifiers and the plurality of data entries can be compared using a natural language processing machine learning technique such as TF-IDF, bag of words, word2vec, and/or bidirectional encoder representations from transformers (BERT) model. In some examples, entity determination system 320 can utilize one of these techniques to determine a similarity score between the plurality of identifiers and the plurality of data entries associated with the one or more profiles. In some examples, the similarity score can be determined using cosine similarity, Levenshtein distance, dot product, etc.

In block 112, in response to the taxpayer identification number not matching a taxpayer identification number associated with one of the one or more profiles, the entity determination system 320 may request validation of the first plurality of identifiers and the taxpayer identification number from the entity device.

In block 114, the entity determination system 320 may determine whether the plurality of identifiers match more than one profile. In some examples, entity determination system 320 can determine that the plurality of identifiers match more than one profile when the entity determination system 320 determines a match beyond a predetermined matching threshold between the plurality of identifiers and more than one profile.

In response to determining that there is a match between only one profile beyond the predetermined matching threshold, in block 116 the entity determination system 320 can notify the entity device of a first profile partial match. In some embodiments, the entity determination system 320 can notify the entity device of a first profile full match when there is a complete match or nearly complete between each of the first plurality of identifiers and the plurality of data entries of the first profile. For example, a similarity metric of 0.9 or higher may indicate a complete match and a similarity metric greater than the predetermined matching threshold but less than 0.9 may indicate a partial match. In some examples, when the entity determination system notifies the entity of a first profile partial match, the entity determination system 320 can provide an indication as to which data entries from external sources (e.g., external database 426) are inconsistent with the plurality of identifiers provided by the entity device 402. Accordingly, a user of entity device 402 can directly contact operators of the appropriate external source for correction.

In response to determining that there are multiple profile matches between beyond the predetermined matching threshold, the method may move to block 118 as described with respect to FIG. 1B.

FIG. 1B is a continuation of the flow diagram of FIG. 1A and illustrates exemplary method 100 for entity resolution, in accordance with certain embodiments of the disclosed technology.

In response to determining that there are multiple profile matches between beyond the predetermined matching threshold, in block 118, the entity determination system 320 may receive merchant data from entity device 402. In some examples, the merchant data can include transaction data collected by a point of service terminal associated with entity device 402. In some examples, the merchant data can include customer details (e.g., name address, contact information, etc.), payment method used (e.g., cash, credit card, debit card, check), inventory details, tax details, and a merchant identifier (e.g., a merchant identification number).

In block 120, the entity determination system 320 may determine whether the plurality of profiles include duplicate profiles each associated with the entity based on the merchant data. For example, the entity determination system 320 may use the merchant identifier received as part of the merchant data to compare to a merchant identifier associated with the one or more profiles (e.g., stored on internal database 416 and/or external database 426).

In block 122, the entity determination system 320 may notify the entity device 402 that the plurality of profiles include duplicate profiles that are each associated with the entity in response to determining that the merchant identifier provided by the entity device 402 matches a merchant identifier associated with multiple profiles of the one or more profiles.

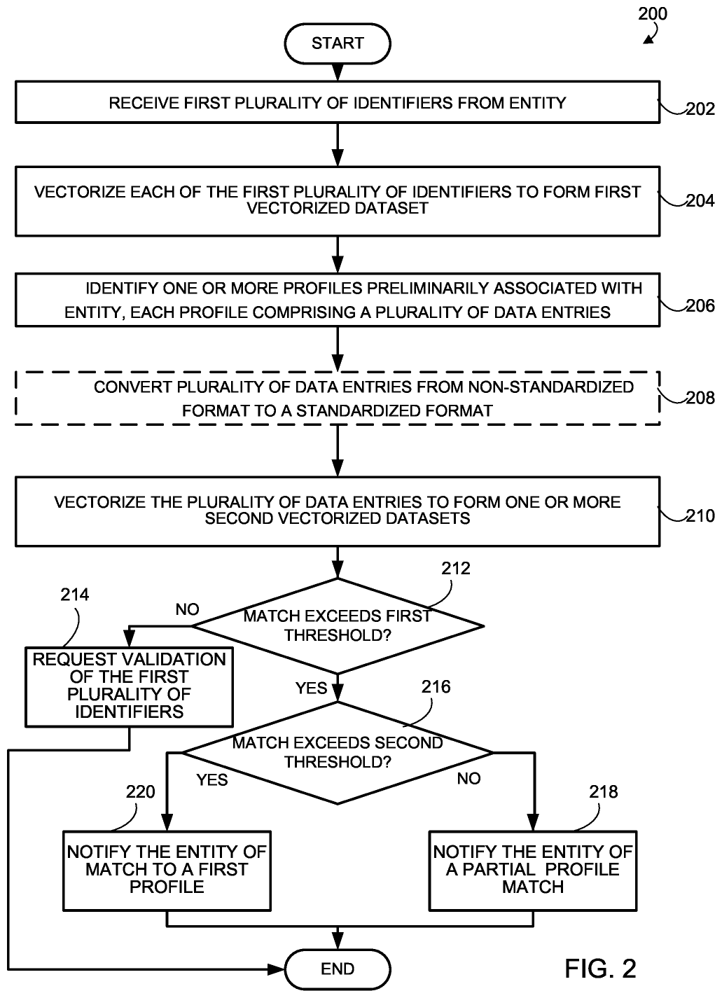

FIG. 2 is a flow diagram illustrating an exemplary method 200 for entity resolution, in accordance with certain embodiments of the disclosed technology. The steps of method 200 may be performed by one or more components of the system 400 (e.g., entity determination system 320 or web server 410 of organization 408 or entity device 402), as described in more detail with respect to FIGS. 3 and 4.

Method 200 of FIG. 2 is similar to method 100 of FIG. 1. The descriptions of blocks 202, 206, 208, 214, and 218 in method 200 are similar to the respective descriptions of blocks 102, 106, 108, 114, and 116 of method 100 and are not repeated herein for brevity. However, blocks 204, 210, 212, 216, 218, and 220 is different from blocks 104, 110, 112, 116, 118, and 120 and are described below.

In block 204, the entity determination system 320 may vectorize each of the first plurality of identifiers to form a first vectorized dataset. For example, the entity determination system 320 can use a machine learning technique selected from TF-IDF, bag of words, word2vec, or BERT to transform the plurality of identifiers into a first vectorized dataset.

In block 210, the entity determination system 320 may vectorize the plurality of data entries to form one or more second vectorized datasets. In some examples each of the one or more second vectorized datasets can be associated with a respective user profile of the one or more user profiles that are preliminarily associated with the first plurality of identifiers.

In decision block 212, the entity determination system 320 may determine whether the match between the first vectorized dataset and any of the one or more second vectorized datasets exceeds a first threshold. As discussed with respect to block 110, the match can be determined based on calculating a similarity score. In some examples, the similarity score can be determined using cosine similarity, Levenshtein distance, dot product, etc. In response to determining that the first vectorized dataset does not exceed the first threshold, the method may move to block 214, which is substantially similar to block 114 and will be omitted for brevity.

In decision block 216, the entity determination system 320 may determine whether the match between the first vectorized dataset and any of the one or more second vectorized datasets exceeds a second threshold. In some examples, the second threshold is higher than the first threshold. In some examples, the match can be determined using a similarity score as discussed with respect to decision block 212. In response to determining that the first vectorized dataset does not match any one of the one or more second vectorized datasets beyond the second predetermined threshold but matches at least one of the second vectorized datasets beyond the first threshold, the method may move to block 218.

In block 218, the entity determination system 320 may, notify the entity of a partial profile match. Block 218 can be substantially similar to block 116 of method 100 and so a full description is omitted here for brevity.

In block 220, the entity determination system 320 may, in response to determining that the first vectorized dataset matches at least one of the one or more second vectorized datasets beyond the second threshold, notify the entity (e.g., via entity device 402) of a match to a first profile. In some examples, more than one of the second vectorized datasets can be found to be a match beyond the second threshold. In some examples, the match can be determined using a similarity score. A similarity score can be calculated using cosine similarity, Levenshtein distance, dot products, etc.

FIG. 3 is a block diagram of an example entity determination system 320 used to determination a match between a plurality of identifiers associated with an entity device and one or more profiles according to an example implementation of the disclosed technology. According to some embodiments, the entity device 402 and web server 410, as depicted in FIG. 4 and described below, may have a similar structure and components that are similar to those described with respect to entity determination system 320 shown in FIG. 3. As shown, the entity determination system 320 may include a processor 310, an input/output (I/O) device 370, a memory 330 containing an operating system (OS) 340 and a program 350. In certain example implementations, the entity determination system 320 may be a single server or may be configured as a distributed computer system including multiple servers or computers that interoperate to perform one or more of the processes and functionalities associated with the disclosed embodiments. In some embodiments entity determination system 320 may be one or more servers from a serverless or scaling server system. In some embodiments, the entity determination system 320 may further include a peripheral interface, a transceiver, a mobile network interface in communication with the processor 310, a bus configured to facilitate communication between the various components of the entity determination system 320, and a power source configured to power one or more components of the entity determination system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the entity determination system 320 may include one or more storage devices configured to store information used by the processor 310 (or other components) to perform certain functions related to the disclosed embodiments. In one example, the entity determination system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The entity determination system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the entity determination system 320 may include the memory 330 that may include one or more programs 350 to perform one or more functions of the disclosed embodiments. For example, in some embodiments, the entity determination system 320 may additionally manage dialogue and/or other interactions with the customer via a program 350.

The processor 310 may execute one or more programs 350 located remotely from the entity determination system 320. For example, the entity determination system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a entity determination system database 360 for storing related data to enable the entity determination system 320 to perform one or more of the processes and functionalities associated with the disclosed embodiments.

The entity determination system database 360 may include stored data relating to status data (e.g., average session duration data, location data, idle time between sessions, and/or average idle time between sessions) and historical status data. According to some embodiments, the functions provided by the entity determination system database 360 may also be provided by a database that is external to the entity determination system 320, such as the database 416 as shown in FIG. 4.

The entity determination system 320 may also be communicatively connected to one or more memory devices (e.g., databases) locally or through a network. The remote memory devices may be configured to store information and may be accessed and/or managed by the entity determination system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The entity determination system 320 may also include one or more I/O devices 370 that may comprise one or more interfaces for receiving signals or input from devices and providing signals or output to one or more devices that allow data to be received and/or transmitted by the entity determination system 320. For example, the entity determination system 320 may include interface components, which may provide interfaces to one or more input devices, such as one or more keyboards, mouse devices, touch screens, track pads, trackballs, scroll wheels, digital cameras, microphones, sensors, and the like, that enable the entity determination system 320 to receive data from a user (such as, for example, via the entity device 402).

In examples of the disclosed technology, the entity determination system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The entity determination system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LS™) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The entity determination system 320 may be configured to adjust model parameters during training. Model parameters may include weights, coefficients, offsets, or the like. Training may be supervised or unsupervised.

The entity determination system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The entity determination system 320 may be configured to optimize statistical models using known optimization techniques.

Furthermore, the entity determination system 320 may include programs configured to retrieve, store, and/or analyze properties of data models and datasets. For example, entity determination system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model. In some examples, the entity determination system 320 can be configured to utilize a natural language processing model, such as TD-IDF, bag of words, word2vec, and/or a bidirectional encoder representations from transformers. In some embodiments, entity determination system 320 can be configured to normalize data sets from a non-standardized format to a standardized format. For example, entity determination system 320 can be configured to adjust the case of the dataset, standardizing any diacritics included in a dataset, removing filling words, removing symbols, and/or standardizing corporate extensions (e.g., converting “limited liability company” to “LLC”, etc.).

The entity determination system 320 may include algorithms to determine a data type, key-value pairs, row-column data structure, statistical distributions of information such as keys or values, or other property of a data schema may be configured to return a statistical profile of a dataset (e.g., using a data-profiling model). The entity determination system 320 may be configured to implement univariate and multivariate statistical methods. The entity determination system 320 may include a regression model, a Bayesian model, a statistical model, a linear discriminant analysis model, or other classification model configured to determine one or more descriptive metrics of a dataset. For example, entity determination system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The entity determination system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, entity determination system 320 may be configured to generate a similarity metric representing a measure of similarity between data in a dataset. A similarity metric may be based on a correlation, covariance matrix, a variance, a frequency of overlapping values, or other measure of statistical similarity. In some embodiments, entity determination system 320 may be configured to generate vectors from selected dataset. The entity determination system 320 may be configured to generate similarity metrics between the generated vectors.

The entity determination system 320 may be configured to generate a similarity metric based on data model output, including data model output representing a property of the data model. For example, entity determination system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The entity determination system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The entity determination system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, entity determination system 320 is configured to generate and/or train a classification model to classify a dataset, consistent with disclosed embodiments.

While the entity determination system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the entity determination system 320 may include a greater or lesser number of components than those illustrated.

FIG. 4 is a block diagram of an example system that may be used to view and interact with organization 408, according to an example implementation of the disclosed technology. The components and arrangements shown in FIG. 4 are not intended to limit the disclosed embodiments as the components used to implement the disclosed processes and features may vary. As shown, organization 408 may interact with an entity device 402 and an external database 426 via a network 406. In certain example implementations, the organization 408 may include a local network 412, an entity determination system 320, a web server 410, and a database 416.

In some embodiments, a user may operate the entity device 402. The entity device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the organization 408. In some embodiments, the entity device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the organization 408. According to some embodiments, the entity device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The organization 408 may be associated with and optionally controlled by one or more entities such as a business, corporation, individual, partnership, or any other entity that provides one or more of goods, services, and consultations to individuals such as customers. In some embodiments, the organization 408 may be controlled by a third party on behalf of another business, corporation, individual, partnership. The organization 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from entity device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the entity device 402. For example, web server 410 may host a financial service provider website that a user device may access by providing an attempted login that are authenticated by the entity determination system 320. According to some embodiments, web server 410 may include software tools, similar to those described with respect to entity device 402 above, that may allow web server 410 to obtain network identification data from entity device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the organization 408 to interact with one another and to connect to the network 406 for interacting with components in the system 400 environment. In some embodiments, the local network 412 may include an interface for communicating with or linking to the network 406. In other embodiments, certain components of the organization 408 may communicate via the network 406, without a separate local network 406.

The organization 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). Entity device 402 may be able to access organization 408 using the cloud computing environment. Entity device 402 may be able to access organization 408 using specialized software. The cloud computing environment may eliminate the need to install specialized software on entity device 402.

In accordance with certain example implementations of the disclosed technology, the organization 408 may include one or more computer systems configured to compile data from a plurality of sources the entity determination system 320, web server 410, the database 416, and/or external database 426. The entity determination system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

External database 426 may be a database associated with a related entity that stores a variety of information relating to customers, transactions, ATM, and business operations. The external database 426 can include information associated with business entities that form profile data, including but not limited to business location data, merchant data, and other business identifiers that the entity determination system 320 can use to determine a match between a plurality of identifiers provided by entity device 402 and one or more profiles stored on external database 426.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes an example of a typical user flow pattern. This section is intended solely for explanatory purposes and not in limitation.

In one example, a business entity with multiple branches wishes to apply for a business bank account. The business entity provides identifying information including a taxpayer identification number. Because the business entity has multiple locations, the system determines that there are multiple existing matches for the business entity. To resolve the duplicate matches, the system requests merchant information from a business entity device, which provides merchant data. The merchant data allows the system to determine that the business entity is one of multiple business entity branches, so that a separate bank account can be opened for the respective entity branch.

As another example, a business may submit an application or a business bank account using the name @mazing Cupcake de WOW Café, Inc. with more than one business address (e.g., 123 Main Street, Sometown, NY 10000 and 211 High Street, Anytown, MI 21000). In some examples, the non-standardized name can be searched through the financial provider database to find matches. Finding a matching account profile can; include calculating a number of letters of the business name that match to the name associated with the one or more stored account profiles (e.g., finding a matching profile can include finding a name associated with a profile that has percentage of character letters that match beyond a predetermined threshold). After the standardization process, the name could be normalized to “AMAZING CUPCAKE DE CAFE INC” and the same search process can be performed as described above. After a match to an account profile is determined, the system can perform a web search and identify external data sources in which the business name is incorrectly reported, for example by identifying businesses listed at the business address (e.g., 123 Main Street, Sometown, NY 10000 and 211 High Street, Anytown, MI 21000) and notifying the business owner when the business name associated with the business addresses is incorrectly listed.

In some examples, disclosed systems or methods may involve one or more of the following clauses:

Clause 1: A system to verify an identity of an entity, the system comprising: one or more processors; and a non-transitory memory storing instructions, that when executed by the one or more processors, are configured to cause the system to: receive a first plurality of identifiers from an entity device associated with the entity, the first plurality of identifiers comprising an entity name, and an entity address; receive a taxpayer identification number associated with the entity; using the first plurality of identifiers, query one or more external data sources to determine one or more profiles preliminarily associated with the entity, each of the one or more profiles comprising a plurality of data entries stored in a non-standardized format dependent on the one or more external data sources; convert the plurality of data entries from the non-standardized format to a standardized format; compare the first plurality of identifiers and the taxpayer identification number to the plurality of data entries in the standardized format; responsive to zero profiles matching the taxpayer identification number beyond a predetermined matching threshold, request validation of the first plurality of identifiers from the entity device; responsive to a first profile matching the taxpayer identification number and one or more of the first plurality of identifiers partially matching the first profile beyond the predetermined matching threshold, notify the entity device of a first profile partial match; and responsive to a plurality of profiles of the one or more profiles matching the taxpayer identification number and the first plurality of identifiers beyond the predetermined matching threshold: receive merchant data from the entity device; determine whether the plurality of profiles comprise duplicate profiles each associated with the entity based on the merchant data; and notify the entity device that the plurality of profiles comprise duplicate profiles each associated with the entity.

Clause 2: The system of clause 1, wherein the merchant data comprises a plurality of purchases processed by a merchant point of service system associated with the entity.

Clause 3: The system of clause 1, wherein determining whether the plurality of profiles comprise duplicate profiles each associated with the entity based on the merchant data further comprises: extracting a first merchant identifier associated with the entity from the merchant data; comparing the first merchant identifier to a second merchant identifier associated with the duplicate profiles; and determining that the duplicate profiles are associated with the entity when the first merchant identifier matches the second merchant identifier beyond the predetermined matching threshold.

Clause 4: The system of clause 1, wherein comparing the first plurality of identifiers and the taxpayer identification number to the plurality of data entries in the standardized format further comprises: vectorizing each of the first plurality of identifiers to form a first vectorized dataset; vectorizing the plurality of data entries to form one or more second vectorized datasets; and determining, using a machine learning model, a match between at least a second vectorized dataset of the one or more second vectorized datasets and the first vectorized dataset, the second vectorized dataset associated with a second profile of the one or more profiles.

Clause 5: The system of clause 4, wherein the machine learning model comprises a model selected from TD-IDF, bag of words, word2vec, bidirectional encoder representations from transformers, and combinations thereof.

Clause 6: The system of clause 1, wherein the non-transitory memory stores instructions, that when executed by the one or more processors, are configured to cause the system to transmit instructions to the one or more external data sources, to modify one or more data entries associated with the first profile partial match.

Clause 7: The system of clause 1, wherein converting the plurality of data entries from the non-standardized format to the standardized format comprises one or more techniques selected from adjusting case, standardizing diacritics, standardizing corporate extensions, removing filler words, removing symbols, or combinations thereof.

Clause 8: A system to verify an identity of an entity, the system comprising: one or more processors; and a non-transitory memory storing instructions, that when executed by the one or more processors, are configured to cause the system to: receive a first plurality of identifiers from an entity device associated with the entity, the first plurality of identifiers comprising an entity name, an entity address and a taxpayer identification number; vectorize each of the first plurality of identifiers to form a first vectorized dataset; identify one or more profiles preliminarily associated with the entity, each of the one or more profiles comprising a plurality of data entries stored in a non-standardized format; convert the plurality of data entries from the non-standardized format to a standardized format; for each of the one or more profiles, vectorize the standardized plurality of data entries to form one or more second vectorized datasets; determine, using a machine learning model, a match between at least a second vectorized dataset of the one or more second vectorized datasets and the first vectorized dataset, the second vectorized dataset associated with a second profile of the one or more profiles; responsive to the match not exceeding a first threshold, request validation of the first plurality of identifiers from the entity device; responsive to the match exceeding the first threshold, notify the entity device of a partial profile match; and responsive to the match exceeding a second threshold, notify the entity device of the match to a first profile of the one or more profiles, the first profile associated with the second vectorized dataset.

Clause 9: The system of clause 8, wherein the machine learning comprises a model selected from TD-IDF, bag of words, word2vec, bidirectional encoder representations from transformers, and combinations thereof.

Clause 10: The system of clause 8, wherein converting the plurality of data entries from the non-standardized format to the standardized format comprises one or more techniques selected from adjusting case, standardizing diacritics, standardizing corporate extensions, removing filler words, removing symbols, and combinations thereof.

Clause 11: The system of clause 8, wherein in response to the first vectorized dataset matching more than one of the one or more second vectorized datasets, the one or more processors are configured to: receive merchant data from the entity device; determine whether the one or more profiles comprise duplicate profiles each associated with the entity based on the merchant data; and notify the entity device that the one or more profiles comprise duplicate profiles each associated with the entity.

Clause 12: The system of clause 11, wherein the merchant data comprises a plurality of purchases processed by a merchant point of service system associated with the entity.

Clause 13: The system of clause 11, wherein determining whether the one or more profiles comprise duplicate profiles each associated with the entity based on the merchant data further comprises: extracting a first merchant identifier associated with the entity from the merchant data; comparing the first merchant identifier to a second merchant identifier associated with the duplicate profiles; and determining that the duplicate profiles are associated with the entity when the first merchant identifier matches the second merchant identifier beyond a third predetermined threshold.

Clause 14: The system of clause 8, wherein requesting validation of the first plurality of identifiers further comprises requesting the entity device provide one or more supporting documents.

Clause 15: A system to verify an identity of an entity, the system comprising: one or more processors; and a non-transitory memory storing instructions, that when executed by the one or more processors, are configured to cause the system to: receive a first plurality of identifiers from an entity device associated with the entity, the first plurality of identifiers comprising an entity name, an entity address and a taxpayer identification number; vectorize each of the first plurality of identifiers to form a first vectorized dataset; identify one or more profiles preliminarily associated with the entity, each of the one or more profiles comprising a plurality of data entries; for each of the one or more profiles, vectorize the plurality of data entries to form one or more second vectorized datasets; determine, using a machine learning model, a match between at least a second vectorized dataset of the one or more second vectorized datasets and the first vectorized dataset, the second vectorized dataset associated with a second profile of the one or more profiles; and responsive to the match not exceeding a first threshold, request validation of the first plurality of identifiers from the entity device; responsive to the match exceeding the first threshold, notify the entity device of a partial profile match; and responsive to the match exceeding a second threshold, notify the entity device of the match to a first profile of the one or more profiles, the first profile associated with the second vectorized dataset.

Clause 16: The system of clause 15, wherein the plurality of data entries are stored in a non-standardized format and the non-transitory memory comprises instructions, that when executed by the one or more processors, are configured to cause the system to convert the plurality of data entries from the non-standardized format to a standardized format.

Clause 17: The system of clause 16, wherein converting the plurality of data entries from the non-standardized format to the standardized format comprises one or more techniques selected from adjusting case, standardizing diacritics, standardizing corporate extensions, removing filler words, removing symbols, and combinations thereof.

Clause 18: The system of clause 15, wherein the machine learning model comprises a model selected from TD-IDF, bag of words, word2vec, bidirectional encoder representations from transformers, and combinations thereof.

Clause 19: The system of clause 15, wherein in response to the first vectorized dataset matching more than one of the one or more second vectorized datasets, the one or more processors are configured to: receive merchant data from the entity device; determine whether the one or more profiles comprise duplicate profiles each associated with the entity based on the merchant data; and notify the entity device that the one or more profiles comprise duplicate profiles each associated with the entity.

Clause 20: The system of clause 19, wherein determining whether the one or more profiles comprise duplicate profiles each associated with the entity based on the merchant data further comprises: extracting a first merchant identifier associated with the entity from the merchant data; comparing the first merchant identifier to a second merchant identifier associated with the duplicate profiles; and determining that the duplicate profiles are associated with the entity when the first merchant identifier matches the second merchant identifier beyond a third predetermined threshold.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system to verify an identity of an entity, the system comprising:
one or more processors; and
a non-transitory memory storing instructions, that when executed by the one or more processors, are configured to cause the system to:
receive a first plurality of identifiers from an entity device associated with the entity, the first plurality of identifiers comprising an entity name, and an entity address;
receive a taxpayer identification number associated with the entity;
using the first plurality of identifiers, query one or more external data sources to determine one or more profiles preliminarily associated with the entity, each of the one or more profiles comprising a plurality of data entries stored in a non-standardized format dependent on the one or more external data sources;
convert the plurality of data entries from the non-standardized format to a standardized format;
compare the first plurality of identifiers and the taxpayer identification number to the plurality of data entries in the standardized format;
responsive to zero profiles matching the taxpayer identification number beyond a predetermined matching threshold, request validation of the first plurality of identifiers from the entity device;
responsive to a first profile matching the taxpayer identification number and one or more of the first plurality of identifiers partially matching the first profile beyond the predetermined matching threshold, notify the entity device of a first profile partial match; and
responsive to a plurality of profiles of the one or more profiles matching the taxpayer identification number and the first plurality of identifiers beyond the predetermined matching threshold:
receive merchant data from the entity device;
determine whether the plurality of profiles comprise duplicate profiles each associated with the entity based on the merchant data; and
notify the entity device that the plurality of profiles comprise duplicate profiles each associated with the entity.

2. The system of claim 1, wherein the merchant data comprises a plurality of purchases processed by a merchant point of service system associated with the entity.

3. The system of claim 1, wherein determining whether the plurality of profiles comprise duplicate profiles each associated with the entity based on the merchant data further comprises:
extracting a first merchant identifier associated with the entity from the merchant data;
comparing the first merchant identifier to a second merchant identifier associated with the duplicate profiles; and
determining that the duplicate profiles are associated with the entity when the first merchant identifier matches the second merchant identifier beyond the predetermined matching threshold.

4. The system of claim 1, wherein comparing the first plurality of identifiers and the taxpayer identification number to the plurality of data entries in the standardized format further comprises:
vectorizing each of the first plurality of identifiers to form a first vectorized dataset;
vectorizing the plurality of data entries to form one or more second vectorized datasets; and
determining, using a machine learning model, a match between at least a second vectorized dataset of the one or more second vectorized datasets and the first vectorized dataset, the second vectorized dataset associated with a second profile of the one or more profiles.

5. The system of claim 4, wherein the machine learning model comprises a model selected from TD-IDF, bag of words, word2vec, bidirectional encoder representations from transformers, and combinations thereof.

6. The system of claim 1, wherein the non-transitory memory stores instructions, that when executed by the one or more processors, are configured to cause the system to transmit instructions to the one or more external data sources, to modify one or more data entries associated with the first profile partial match.

7. The system of claim 1, wherein converting the plurality of data entries from the non-standardized format to the standardized format comprises one or more techniques selected from adjusting case, standardizing diacritics, standardizing corporate extensions, removing filler words, removing symbols, or combinations thereof.

8. A system to verify an identity of an entity, the system comprising:
one or more processors; and
a non-transitory memory storing instructions, that when executed by the one or more processors, are configured to cause the system to:
receive a first plurality of identifiers from an entity device associated with the entity, the first plurality of identifiers comprising an entity name, an entity address and a taxpayer identification number;
vectorize each of the first plurality of identifiers to form a first vectorized dataset;
identify one or more profiles preliminarily associated with the entity, each of the one or more profiles comprising a plurality of data entries stored in a non-standardized format;
convert the plurality of data entries from the non-standardized format to a standardized format;
for each of the one or more profiles, vectorize the standardized plurality of data entries to form one or more second vectorized datasets;
determine, using a machine learning model, a match between at least a second vectorized dataset of the one or more second vectorized datasets and the first vectorized dataset, the second vectorized dataset associated with a second profile of the one or more profiles;
responsive to the match not exceeding a first threshold, request validation of the first plurality of identifiers from the entity device;
responsive to the match exceeding the first threshold, notify the entity device of a partial profile match; and
responsive to the match exceeding a second threshold, notify the entity device of the match to a first profile of the one or more profiles, the first profile associated with the second vectorized dataset.

9. The system of claim 8, wherein the machine learning comprises a model selected from TD-IDF, bag of words, word2vec, bidirectional encoder representations from transformers, and combinations thereof.

10. The system of claim 8, wherein converting the plurality of data entries from the non-standardized format to the standardized format comprises one or more techniques selected from adjusting case, standardizing diacritics, standardizing corporate extensions, removing filler words, removing symbols, and combinations thereof.

11. The system of claim 8, wherein in response to the first vectorized dataset matching more than one of the one or more second vectorized datasets, the one or more processors are configured to:
receive merchant data from the entity device;
determine whether the one or more profiles comprise duplicate profiles each associated with the entity based on the merchant data; and
notify the entity device that the one or more profiles comprise duplicate profiles each associated with the entity.

12. The system of claim 11, wherein the merchant data comprises a plurality of purchases processed by a merchant point of service system associated with the entity.

13. The system of claim 11, wherein determining whether the one or more profiles comprise duplicate profiles each associated with the entity based on the merchant data further comprises:
extracting a first merchant identifier associated with the entity from the merchant data;
comparing the first merchant identifier to a second merchant identifier associated with the duplicate profiles; and
determining that the duplicate profiles are associated with the entity when the first merchant identifier matches the second merchant identifier beyond a third predetermined threshold.

14. The system of claim 8, wherein requesting validation of the first plurality of identifiers further comprises requesting the entity device provide one or more supporting documents.

15. A system to verify an identity of an entity, the system comprising:
one or more processors; and
a non-transitory memory storing instructions, that when executed by the one or more processors, are configured to cause the system to:
receive a first plurality of identifiers from an entity device associated with the entity, the first plurality of identifiers comprising an entity name, an entity address and a taxpayer identification number;
vectorize each of the first plurality of identifiers to form a first vectorized dataset;
identify one or more profiles preliminarily associated with the entity, each of the one or more profiles comprising a plurality of data entries;
for each of the one or more profiles, vectorize the plurality of data entries to form one or more second vectorized datasets;
determine, using a machine learning model, a match between at least a second vectorized dataset of the one or more second vectorized datasets and the first vectorized dataset, the second vectorized dataset associated with a second profile of the one or more profiles; and
responsive to the match not exceeding a first threshold, request validation of the first plurality of identifiers from the entity device;
responsive to the match exceeding the first threshold, notify the entity device of a partial profile match; and
responsive to the match exceeding a second threshold, notify the entity device of the match to a first profile of the one or more profiles, the first profile associated with the second vectorized dataset.

16. The system of claim 15, wherein the plurality of data entries are stored in a non-standardized format and the non-transitory memory comprises instructions, that when executed by the one or more processors, are configured to cause the system to convert the plurality of data entries from the non-standardized format to a standardized format.

17. The system of claim 16, wherein converting the plurality of data entries from the non-standardized format to the standardized format comprises one or more techniques selected from adjusting case, standardizing diacritics, standardizing corporate extensions, removing filler words, removing symbols, and combinations thereof.

18. The system of claim 15, wherein the machine learning model comprises a model selected from TD-IDF, bag of words, word2vec, bidirectional encoder representations from transformers, and combinations thereof.

19. The system of claim 15, wherein in response to the first vectorized dataset matching more than one of the one or more second vectorized datasets, the one or more processors are configured to:
receive merchant data from the entity device;
determine whether the one or more profiles comprise duplicate profiles each associated with the entity based on the merchant data; and
notify the entity device that the one or more profiles comprise duplicate profiles each associated with the entity.

20. The system of claim 19, wherein determining whether the one or more profiles comprise duplicate profiles each associated with the entity based on the merchant data further comprises:
extracting a first merchant identifier associated with the entity from the merchant data;
comparing the first merchant identifier to a second merchant identifier associated with the duplicate profiles; and
determining that the duplicate profiles are associated with the entity when the first merchant identifier matches the second merchant identifier beyond a third predetermined threshold.
